(19) United States
(12) Patent Application Publication
(10) Pub. No.: US 2025/0072318 A1
(43) Pub. Date: Mar. 6, 2025

(54) WORKING ROBOT

(71) Applicant: MAKITA CORPORATION, Anjo-shi (JP)

(72) Inventors: Tatsuya YOSHIKAWA, Anjo-shi (JP); Genki TOYODA, Anjo-shi (JP)

(73) Assignee: MAKITA CORPORATION, Anjo-shi (JP)

(21) Appl. No.: 18/797,646

(22) Filed: Aug. 8, 2024

(30) Foreign Application Priority Data
Aug. 31, 2023 (JP) 2023-141493

(51) Int. Cl. A01D 34/00; A01D 101/00; G05D 1/244; G05D 1/85; G05D 105/15; G05D 107/20

(52) U.S. Cl. CPC A01D 34/008; G05D 1/244; G05D 1/857; A01D 2101/00; G05D 2105/15; G05D 2107/23

(57) ABSTRACT

A working robot may include a body, a movement unit, a working unit, a magnetic sensor supported by the body, and a control unit. The control unit may be configured to execute a working operation of causing the working unit to work while causing the movement unit to move the body. The control unit may execute, during the working operation, an operation-suspending process of suspending the working operation when a predetermined operation-suspending condition is satisfied, a first magnetic field searching process of causing the movement unit to move the body straight in a first linear direction by a first distance and assessing whether a wire magnetic field is detected by the magnetic sensor after the operation-suspending process, and an operation-resuming process of resuming the working operation when the wire magnetic field is detected by the magnetic sensor.

### REFERENCE TO RELATED APPLICATIONS

This application claims priority from Japanese Patent Application No. 2023-141493 filed on Aug. 31, 2023. The entire content of the priority application is incorporated herein by reference.

### TECHNICAL FIELD

An art disclosed herein relates to a working robot.

### BACKGROUND ART

Japanese Patent Application Publication No. 2016-207158 describes a working robot used in a working field in which a wire is installed, and configured to move and work based on a wire magnetic field generated around the wire. The working robot includes a body, a movement unit configured to move the body, a working unit supported by the body, a magnetic sensor supported by the body, and a control unit. The control unit is configured to execute a working operation of causing the working unit to work while causing the movement unit to move the body.

### SUMMARY

For example, if a power outage cuts off application of an electrical signal to the wire, the wire magnetic field cannot be generated, thereby resulting in the wire magnetic field becoming undetected by the magnetic sensor. Normally, if the wire magnetic field becomes undetected by the magnetic sensor during execution of the working operation, the working operation is suspended. However, a certain positional relationship between the magnetic sensor and the wire may make the wire magnetic field undetectable by the magnetic sensor despite the wire magnetic field being generated. In this case, the working operation may be suspended, but it is preferable to immediately resume the working operation. If a situation in which the wire magnetic field is undetected despite the wire magnetic field being generated continues, the work using the working robot may not proceed smoothly because the working operation cannot be resumed. The present teachings provide an art configured to allow the work using the working robot to proceed smoothly.

A working robot disclosed herein may be used in a working field in which a wire is installed and configured to move and work based on a wire magnetic field generated around the wire. The working robot may comprise a body, a movement unit configured to move the body, a working unit supported by the body, a magnetic sensor supported by the body, and a control unit. The control unit may be configured to execute a working operation of causing the working unit to work while causing the movement unit to move the body. The control unit may execute, during the working operation, an operation-suspending process of suspending the working operation when a predetermined operation-suspending condition is satisfied, a first magnetic field searching process of causing the movement unit to move the body straight in a first linear direction by a first distance and assessing whether the wire magnetic field is detected by the magnetic sensor after the operation-suspending process, and an operation-resuming process of resuming the working operation when the wire magnetic field is detected by the magnetic sensor.

Even in a case where it is expected that the wire magnetic field will not be detected by the magnetic sensor, the wire magnetic field may be detected when a positional relationship between the magnetic sensor and the wire is changed. According to the above configuration, when the operation-suspending condition is satisfied (when it is expected that the wire magnetic field will not be detected by the magnetic sensor), detection for the wire magnetic field by the magnetic sensor can be attempted while changing the positional relationship between the magnetic sensor and the wire. Due to this, the situation where the wire magnetic field is undetected by the magnetic sensor despite the wire magnetic field being generated can be suppressed from continuing. Further, when the wire magnetic field is detected by the magnetic sensor during the suspension of the working operation, the control unit can automatically resume the working operation. Due to this, the working operation can be resumed without a user's help, and the work using the working robot can be smoothly proceeded.

### BRIEF DESCRIPTION OF DRAWINGS

FIG. 1 illustrates an example for use of a robotic mower 2 according to an embodiment.

FIG. 2 illustrates a left view of the robotic mower 2 according to the embodiment.

FIG. 3 illustrates a back view of the robotic mower 2 according to the embodiment.

FIG. 4 illustrates a schematic configuration of the robotic mower 2 according to the embodiment.

FIG. 5 illustrates a layout of a plurality of magnetic sensors 38 of the robotic mower 2 according to the embodiment.

FIG. 6A illustrates an example for a magnetic signal observed by the plurality of magnetic sensors 38 of the robotic mower 2 according to the embodiment.

FIG. 6B illustrates an example for a magnetic signal observed by the plurality of magnetic sensors 38 of the robotic mower 2 according to the embodiment.

FIG. 7 illustrates an example of a signal model SM stored in a memory 24 of the robotic mower 2 according to the embodiment.

FIG. 8 illustrates a wire magnetic field M generated around a wire 112 according to the embodiment and variation in intensity of the wire magnetic field M in an up-down direction.

FIG. 9 illustrates a flowchart of processes executed by a control unit 8 of the robotic mower 2 according to the embodiment.

FIG. 10 illustrates a state in which each of the plurality of magnetic sensors 38 of the robotic mower 2 according to the embodiment is positioned directly above the wire 112 (i.e., boundary of a working area WA).

FIG. 11 illustrates how the robotic mower 2 according to the embodiment operates according to the processes illustrated in FIG. 9.

FIG. 12 illustrates how the robotic mower 2 according to the embodiment operates according to the processes illustrated in FIG. 9.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working robots as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the operation-suspending condition may include that the wire magnetic field becomes undetected by the magnetic sensor.

According to the above configuration, when the wire magnetic field becomes undetected by the magnetic sensor even while the wire magnetic field is generated, the operation-suspending condition is satisfied, by which the working operation is suspended. However, when the operation-suspending condition is satisfied, the control unit can attempt to detect the wire magnetic field while changing the positional relationship between the magnetic sensor and the wire. Due to this, the situation in which the wire magnetic field is undetected by the magnetic sensor despite the wire magnetic field being generated can be suppressed from continuing.

In one or more embodiments, the magnetic sensor may comprise a plurality of magnetic sensors. The operation-suspending condition may include that the wire magnetic field becomes undetected by a predetermined number or more of magnetic sensors among the plurality of magnetic sensors. The predetermined number may be greater than a half of a total of the plurality of magnetic sensors.

As to the wire magnetic field generated around the wire, intensity of the magnetic field in the up-down direction is substantially zero directly above the wire or directly below the wire. Due to this, in a case where the magnetic sensor is configured to observe a vertical magnetic field (that is, magnetic field in the up-down direction), the wire magnetic field becomes undetected by the magnetic sensor when the magnetic sensor is positioned directly above the wire. There is a technique which uses this characteristic to determine that a magnetic sensor is positioned directly above a wire when a wire magnetic field is not detected by the magnetic sensor. Considering this technique, even if the wire magnetic field was undetected by some of a plurality of magnetic sensors, it is highly probable that the wire magnetic field is generated when the number of the magnetic sensors which do not detect the wire magnetic field is small. If the series of processes following the operation-suspending process is performed in this case also, the working operation results in being unnecessarily suspended, and thus the work using the working robot cannot proceed smoothly. According to the above configuration, when the number of the magnetic sensors which do not detect the wire magnetic field is large, the operation-suspending condition is satisfied, by which the series of processes following the operation-suspending process is performed. When the number of the magnetic sensors which do not detect the wire magnetic field is small, the operation-suspending condition is not satisfied, by which the series of processes following the operation-suspending process is not performed. As such, the series of processes following the operation-suspending process is performed only when it is less probable that the wire magnetic field is generated, the unnecessary suspension of the working operation can be suppressed. Due to this, the work using the working robot can be smoothly proceeded.

In one or more embodiments, the wire magnetic field may include a wire magnetic signal generated by applying a predetermined electrical signal to the wire. The control unit may have a signal model of the wire magnetic signal stored therein in advance. When a magnetic signal observed by the magnetic sensor matches or resembles the signal model of the wire magnetic signal, the control unit may assess that the wire magnetic field is detected by the magnetic sensor.

According to the above configuration, whether the wire magnetic field is detected or not by the magnetic sensor can be determined with a simple means.

In one or more embodiments, the control unit may be configured to determine a direction in which the body moved before the working operation is suspended and set an opposite direction from the determined direction as the first linear direction in the first magnetic field searching process.

There is a case where, in the example where an area surrounded by the wire is defined as a working area for the working robot, the operation-suspending condition may be satisfied when the magnetic sensor comes directly above the wire and thus the wire magnetic field becomes undetected by the magnetic sensor. In this case, because the body is assumed as being on or near the boundary of the working area, the body may go outside the working area if the body is randomly moved in the first magnetic field searching process executed thereafter. According to the above configuration, the control unit causes the body to return to a spot at which the body was before the operation-suspending condition was satisfied in the first magnetic field searching process. Since the wire magnetic field must have been detected by the magnetic sensor right before the operation-suspending condition was satisfied, it can be assumed that the body was inside the working area. Accordingly, the body can be moved so as to approach the inside of the working area, and thus the body can be suppressed from going outside the working area.

In one or more embodiments, after the first magnetic field searching process, the control unit may be configured to further execute a second magnetic field searching process of causing the movement unit to move the body straight in a second linear direction opposite to the first linear direction by a second distance and assessing whether the wire magnetic field is detected by the magnetic sensor.

According to the above configuration, after the first magnetic field searching process, detection for the wire magnetic field by the magnetic sensor can be attempted while changing the positional relationship between the magnetic sensor and the wire again. Due to this, the situation where the wire magnetic field is undetected by the magnetic sensor despite the wire magnetic field being generated can be more certainly resolved.

In one or more embodiments, when the wire magnetic field is detected in the first magnetic field searching process, the control unit may not execute the second magnetic field searching process. When the wire magnetic field is not detected in the first magnetic field searching process, the control unit may execute the second magnetic field searching process.

According to the above configuration, in the case where the wire magnetic field is detected in the first magnetic field searching process, the control unit can omit the second magnetic field searching process and immediately resume the working operation. Due to this, the work using the working robot can be smoothly proceeded.

In one or more embodiments, the second distance may be the same as the first distance.

If the working operation is resumed at a spot different from the spot at which the working operation was suspended, the working operation may possibly end with a spot at which the working robot has not worked on yet (undone spot) remaining. According to the above configuration, the position of the body when the second magnetic field searching process is finished is almost not displaced from the position of the body when the working operation was suspended. Due to this, the working operation can be resumed from the spot at which the working operation was suspended by resuming the working operation after the second magnetic field searching process is finished. Accordingly, the working operation can be suppressed from ending with an undone spot remaining.

In one or more embodiments, the second distance may be less than the first distance.

There is a case where the operation-suspending condition may be satisfied when the magnetic sensor comes directly above the wire and accordingly the wire magnetic field becomes undetected by the magnetic sensor. In this case, if the position of the body when the second magnetic field searching process is finished is not displaced at all from the position of the body when the wire magnetic field becomes undetected by the magnetic sensor, the magnetic sensor would go again directly above the wire. Due to this, even if the wire magnetic field is detected in the first magnetic field searching process or in the second magnetic field searching process, the wire magnetic field may become undetected by the magnetic sensor after the second magnetic field searching process has finished. As a result, even if the working operation is resumed, the working operation would be immediately suspended, as a result of which the work using the working robot may not smoothly proceeded. According to the above configuration, the position of the body when the second magnetic field searching process is finished can be displaced from the position of the body when the wire magnetic field becomes undetected by the magnetic sensor. Due to this, the magnetic sensor can be suppressed from coming directly above the wire when the second magnetic field searching process is finished. Due to this, as long as the wire magnetic field is generated, even after the second magnetic field searching process is finished, the wire magnetic field can be detected by the magnetic sensor. Accordingly, because the working operation can be suppressed from being suspended immediately after the working operation is resumed, the work using the working robot can be smoothly proceeded.

In one or more embodiments, the first distance may be less than or equal to 1000 mm.

If the body is moved to a great degree after the wire magnetic field has become undetected by the magnetic sensor, the body may be gone to an unexpected spot (e.g., a spot where an obstacle is present). According to the above configuration, the body can be suppressed from moving to a great degree after the wire magnetic field has become undetected by the magnetic sensor. Accordingly, the body can be suppressed from going to an unexpected spot.

In one or more embodiments, the first distance may be less than or equal to a total length of the working robot.

If the body is moved to a great degree after the wire magnetic field has become undetected by the magnetic sensor, the body may be gone to an unexpected spot (e.g., a spot where an obstacle is present). According to the above configuration, the body can be suppressed from moving to a great degree after the wire magnetic field has become undetected by the magnetic sensor. Accordingly, the body can be suppressed from going to an unexpected spot.

In one or more embodiments, the control unit may be configured to further execute an informing process of informing via an informing interface that an abnormality has occurred. When a predetermined time elapses without the operation-resuming process being executed after the first magnetic field searching process has finished, the control unit may execute the informing process.

According to the above configuration, in a case where the wire magnetic field is not detected by the magnetic sensor and thus the working operation is not resumed even after the first magnetic field searching process, it is possible to inform the user of that situation.

In one or more embodiments, the control unit may be configured to further execute an informing process of informing via an informing interface that an abnormality has occurred. When a predetermined time elapses without the operation-resuming process being executed after the second magnetic field searching process has finished, the control unit may execute the informing process.

According to the above configuration, in a case where the wire magnetic field is not detected by the magnetic sensor and thus the working operation is not resumed even after the first magnetic field searching process and the second magnetic field searching process, it is possible to inform the user of that situation.

In one or more embodiments, the working unit may comprise a blade configured to mow a lawn. The working robot may function as an autonomous mobile robotic mower.

According to the above configuration, mowing operation by the robotic mower can be smoothly proceeded.

### Embodiment

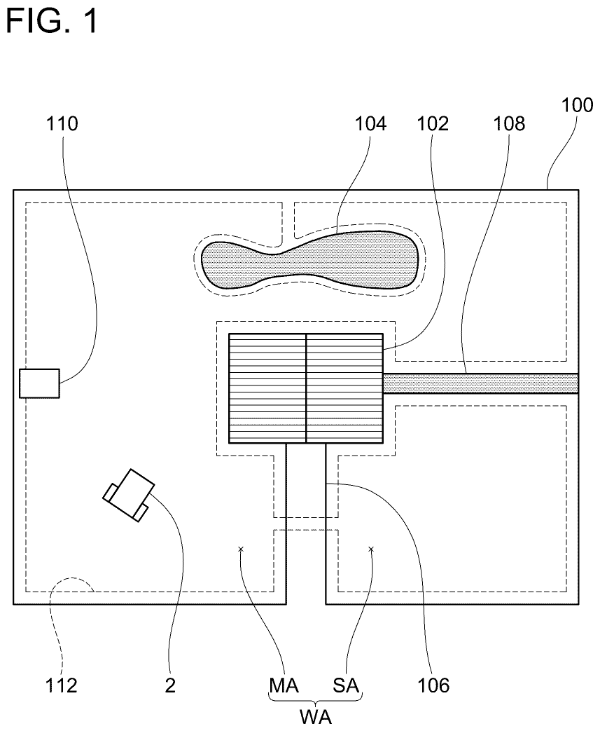

As illustrated in FIG. 1, a working robot according to a present embodiment is a robotic mower 2 used in a lawned site 100. In the site 100, for example, a house 102, a pond 104, a road 106, and a fence 108 are arranged. Also, in the site 100, a charging station 110 connected to an external power supply (e.g., commercial power) and a wire 112 defining a working area WA for the robotic mower 2 are installed. The working area WA herein is an area encircled by the wire 112. The working area WA for the robotic mower 2 is sectioned into a main area MA including the charging station 110 and a secondary area SA which does not include the charging station 110. The robotic mower 2 is configured to detect a location of the wire 112 and autonomously move so that the robotic mower 2 does not depart from the working area WA (the main area MA in an example of FIG. 1) in which the robotic mower 2 is positioned. Due to this, the robotic mower 2 can mow the lawn as it moves on the lawn while avoiding the house 102, the pond 104, the road 106, and the fence 108.

A total length of the robotic mower 2 is in a range of 500 mm to 1000 mm for example, and is 700 mm in the present embodiment. A total width of the robotic mower 2 is in a range of 300 mm to 600 mm for example, and is 560 mm in the present embodiment. A total height of the robotic mower 2 is in a range of 200 mm to 300 mm for example, and is 270 mm in the present embodiment.

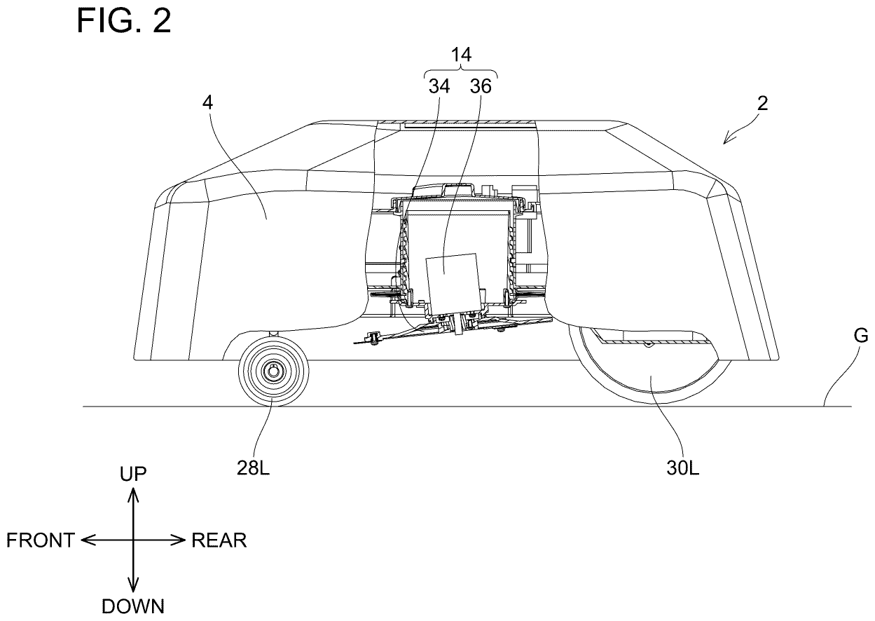

As illustrated in FIGS. 2, 3, and 4, the robotic mower 2 comprises a body 4, a power unit 6, a control unit 8, an operation unit 10, a display unit 11, a movement unit 12, a working unit 14, a detection unit 16, a communication unit 50, and an alarm unit 52. The power unit 6, the control unit 8, the operation unit 10, the display unit 11, the movement unit 12, the working unit 14, the detection unit 16, the communication unit 50, and the alarm unit 52 are respectively supported by the body 4.

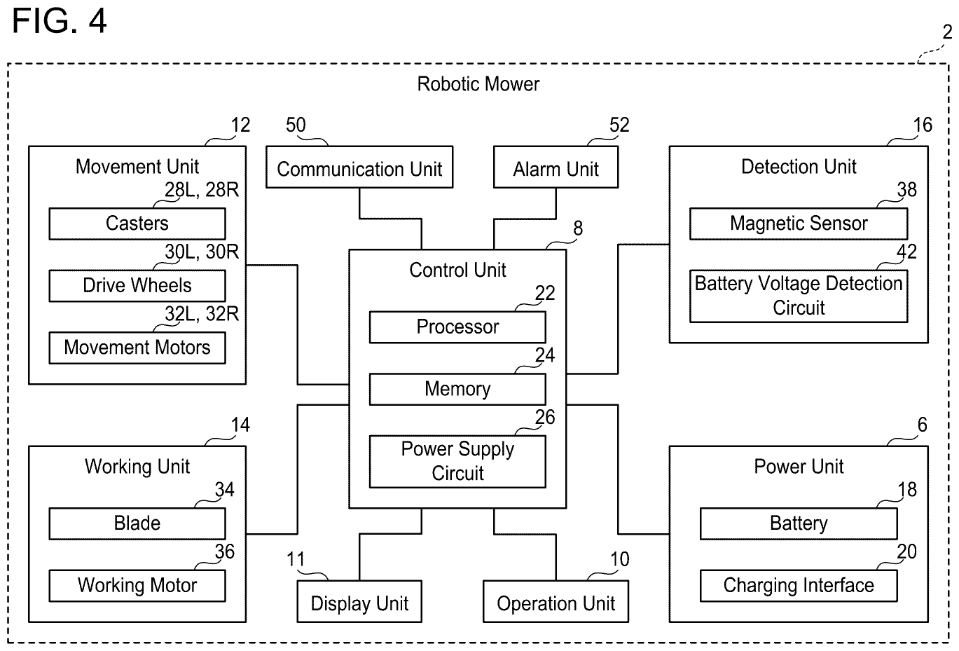

The power unit 6 illustrated in FIG. 4 is configured to supply power to respective components of the robotic mower 2 via a power circuit 26 of the control unit 8. The power unit 6 comprises a rechargeable battery 18 such as a lithium-ion battery and a charging interface 20 electrically connected to the battery 18. A nominal capacity of the battery 18 is for example 5.0 Ah. A nominal voltage of the battery 18 is for example 18V. The robotic mower 2 is configured to be docked to the charging station 110 (see FIG. 1) via the charging interface 20. In a state where the robotic mower 2 is docked to the charging station 110, the battery 18 can be charged with power supplied from the charging station 110. A charging scheme of the battery 18 may be wired charging. Specifically, the battery 18 may be charged with a terminal disposed in the charging station 110 and a terminal disposed in the charging interface 20 being coupled to each other. Alternatively, the charging scheme of the battery 18 may be wireless charging. Specifically, the battery 18 may be charged by a power transmission coil disposed in the charging station 110 causing a power reception coil disposed in the charging interface 20 to generate induced electromotive force.

The control unit 8 comprises a processor 22, a memory 24, and the power circuit 26. The memory 24 includes ROM, RAM for example. The memory 24 has a program for autonomously controlling the robotic mower 2 stored therein. The processor 22 is configured to autonomously control the robotic mower 2 in accordance with the program stored in the memory 24. The memory 24 further stores setting related to the robotic mower 2 (e.g., cutting length for the lawn) stored therein. Setting related to an operation mode of the robotic mower 2 is also included in the setting related to the robotic mower 2. The operation mode of the robotic mower 2 is set in one of a plurality of modes including a main area-specific mode which complies with the main area MA (see FIG. 1) and a secondary area-specific mode which complies with the secondary area SA (see FIG. 1).

The operation unit 10 is arranged, for example, on an outer surface of the body 4 (see FIG. 2), and comprises a switch configured to be operated by a user. The user can perform various operations related to the robotic mower 2 via the operation unit 10. The various operations herein mentioned include for example an operation of switching on/off of main power of the robotic mower 2, an operation of inputting an instruction for the robotic mower 2, and an operation of changing the setting related to the robotic mower 2.

The display unit 11 comprises, for example, a display configured to display character(s) and/or image(s) (not illustrated) and a light source device configured to indicate a state of the robotic mower 2 with chromaticity and/or blinking pattern of light. The state of the robotic mower 2 herein mentioned includes for example a state of charging the battery 18 and/or a state of an abnormality occurring in the robotic mower 2.

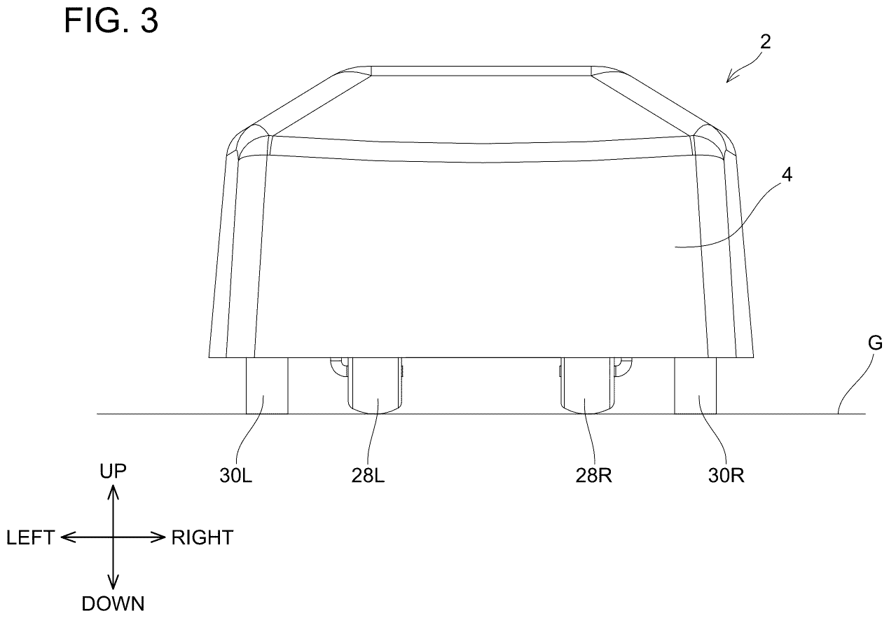

The movement unit 12 comprises a pair of left and right casters 28L, 28R, a pair of left and right driving wheels 30L, 30R, and a pair of left and right movement motors 32L, 32R. The movement motors 32L, 32R are for example brushless DC motors. Output shafts of the movement motors 32L, 32R are respectively coupled to the driving wheels 30L, 30R. As illustrated in FIGS. 2 and 3, the robotic mower 2 is placed on a ground G with the casters 28L, 28R and the driving wheels 30L, 30R in contact with the ground G. The movement unit 12 is configured to cause the body 4 to go forward, go backward, and turn by driving the movement motors 32L, 32R (see FIG. 4) to rotate the driving wheels 30L, 30R. In the present embodiment, a direction perpendicular to the ground G and oriented from the ground G toward the body 4 will be denoted “up direction/upward”, and a direction perpendicular to the ground and oriented from the body 4 toward the ground G will be denoted “down direction/downward”. A direction perpendicular to the up-down direction and oriented from the driving wheel 30R toward the driving wheel 30L will be denoted “left direction/leftward” and a direction perpendicular to the up-down direction and oriented from the driving wheel 30L toward the driving wheel 30R will be denoted “right direction/rightward”. A direction perpendicular to both the up-down and left-right directions and oriented from the driving wheels 30L, 30R toward the casters 28L, 28R will be denoted “front direction/frontward” and a direction perpendicular to both the up-down and left-right directions and oriented from the casters 28L, 28R toward the driving wheels 30L, 30R will be denoted “rear direction/rearward”.

As illustrated in FIG. 2, the working unit 14 comprises a blade 34 and a working motor 36. The blade 34 is a rotary blade shaped in a substantially disk. The working motor 36 is for example a brushless DC motor. The working motor 36 is supported by the body 4 with its output shaft in an inclined state from front to rear as the output shaft goes from up to down. The blade 34 is coupled to the output shaft of the working motor 36. The working unit 14 is configured to mow the lawn by operating the working motor 36 and thus rotating the blade 34.

As illustrated in FIG. 4, the detection unit 16 comprises a plurality of magnetic sensors 38 and a battery voltage detection circuit 42.

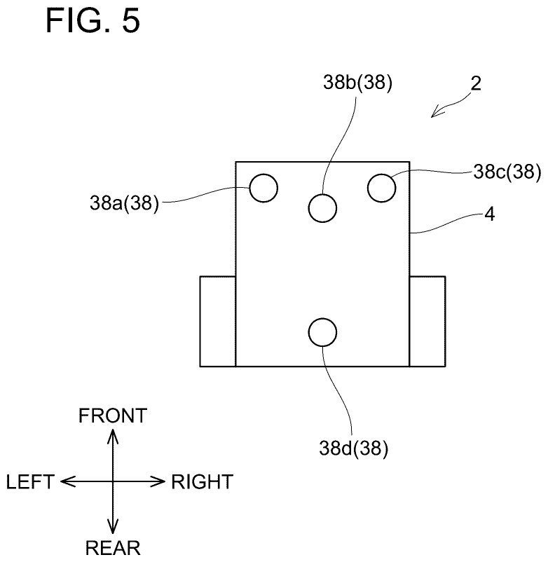

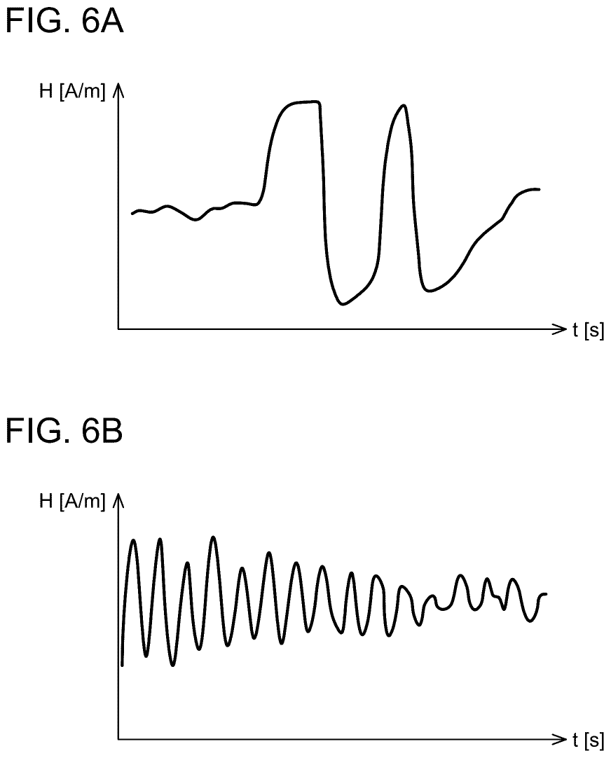

As illustrated in FIG. 5, the plurality of magnetic sensors 38 comprises four magnetic sensors 38a, 38b, 38c, 38d. The magnetic sensor 38a is disposed on a front-left portion of the body 4. The magnetic sensor 38b is disposed on a front-center portion of the body 4. The magnetic sensor 38c is disposed on a front-right portion of the body 4. The magnetic sensor 38d is disposed on a rear-center portion of the body 4. Each of the plurality of magnetic sensors 38 is for example a Hall sensor. Each of the magnetic sensors 38 is configured to observe temporal change in intensity of vertical magnetic field (that is, magnetic field in the up-down direction) as a magnetic signal such as illustrated in FIG. 6A and FIG. 6B and output an observation result to the control unit 8 (see FIG. 4).

The battery voltage detection circuit 42 illustrated in FIG. 4 is configured to detect a voltage value of the battery 18 and output the same to the control unit 8. Due to this, the control unit 8 can acknowledge the voltage value of the battery 18.

The communication unit 50 is an interface for connecting to the Internet via a base station (not illustrated) of mobile communication (e.g., 3G, 4G, 5G) or a router (not illustrated) installed on the house 102. The control unit 8 is configured to communicate wirelessly with a communication terminal (e.g., smartphone) which the user has via the communication unit 50. Due to this, the control unit 8 can inform the communication terminal which the user has of an occurrence of abnormality in the robotic mower 2, for example.

The alarm unit 52 comprises a buzzer (not illustrated). The alarm unit 52 is configured to inform of abnormality occurring in the robotic mower 2 by emitting a sound.

Hereafter, a mowing operation executed by the control unit 8 (specifically the processor 22) will be described.

The mowing operation is a main operation by the robotic mower 2. The mowing operation is started for example when a start of the mowing operation is instructed via the operation unit 10 with power of the robotic mower 2 on. When the mowing operation has started, the control unit 8 confirms that there is no abnormality occurring in the robotic mower 2 and then starts a mowing work by the robotic mower 2. That is, the control unit 8 drives the driving wheels 30L, 30R by the movement motors 32L, 32R while causing the working motor 36 to drive the blade 34, thereby mowing the lawn. In a case where the operation mode of the robotic mower 2 is set in the main area-specific mode, when a remaining level of the battery 18 lowers, the control unit 8 causes the body 4 to return to the charging station 110 (see FIG. 1), and charges the battery 18. When a predetermined operation ending condition is satisfied, the control unit 8 finishes the mowing operation. The operation ending condition herein mentioned includes for example a time elapsed since the mowing operation was started reaches a time which was set in advance by the user.

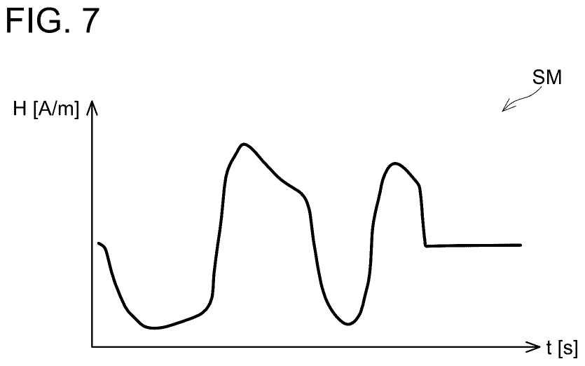

The wire 112 illustrated in FIG. 1 is applied with a predetermined electric signal by the charging station 110. Due to this, a magnetic field including a magnetic signal corresponding to the predetermined electric signal (the wire magnetic field M) is generated about the wire 112. The memory 24 (see FIG. 4) has a signal model SM of a wire magnetic signal as illustrated in FIG. 7 stored therein in advance. The control unit 8 (see FIG. 4) is configured to assess whether the signal model SM matches the magnetic signal observed by each of the plurality of magnetic sensors 38 (see FIG. 5) or not during execution of the mowing operation. As an example for a way to assess whether two signals match or resemble each other, correlated analysis is used. For example, in a case where the magnetic signal illustrated in FIG. 6A is observed by the magnetic sensor 38, such magnetic signal is assessed as resembling the signal model SM illustrated in FIG. 7. Contrary to this, in a case where the magnetic signal illustrated in FIG. 6B is observed by the magnetic sensor 38, such magnetic signal is assessed as neither matching nor resembling the signal model SM illustrated in FIG. 7. In the present embodiment, in the case where a magnetic signal matching or resembling the signal model SM is observed by the magnetic sensor 38, the control unit 8 assesses that the wire magnetic field M has been detected by such magnetic sensor 38.

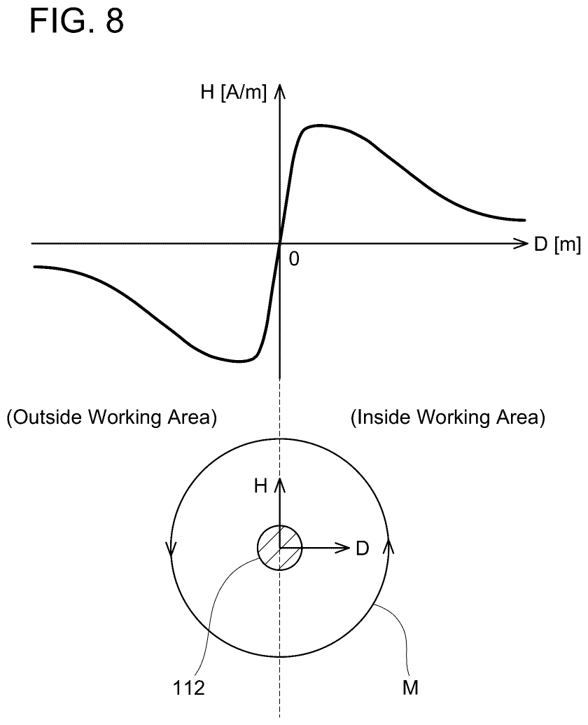

As illustrated in FIG. 8, the wire magnetic field M is generated in a manner of encircling the wire 112 according to right-handed screw rule. Accordingly, a direction of the wire magnetic field M generated inside the working area WA and a direction of the wire magnetic field M generated outside the working area WA are reversed from each other. That is, a phase of the wire magnetic signal generated inside the working area WA and a phase of the wire magnetic signal generated outside the working area WA are opposite from each other. In a case where the wire magnetic field M is detected by the magnetic sensor 38 (see FIG. 5), this characteristic is utilized for the control unit 8 (see FIG. 4) to determine whether the magnetic sensor 38 is inside or outside the working area WA based on the phase of the magnetic signal observed by the magnetic sensor 38. Further, the intensity of the wire magnetic field M in the up-down direction is substantially zero directly above the wire 112 (i.e., boundary of the working area WA). Due to this, when the magnetic sensor 38 is directly above the wire 112 (i.e., boundary of the working area WA), the wire magnetic field M becomes undetected by the magnetic sensor 38. This characteristic is used for the control unit 8 to assess that the magnetic sensor 38 is on the boundary of the working area WA when the wire magnetic field M becomes undetected by the magnetic sensor 38. For each of the plurality of magnetic sensors 38, the control unit 8 determines which of the inside, the boundary, or the outside of the working area WA the magnetic sensor 38 is at, and thereby determines a positional relationship between the body 4 (see FIG. 5) and the wire 112. The control unit 8 causes the body 4 to move such that the body 4 does not depart from the working area WA based on the determined positional relationship between the body 4 and the wire 112. Here, in a graph illustrated in FIG. 8, an abscissa axis is a distance D between the wire 112 and the magnetic sensor 38 in the front and left-right directions and an ordinate axis is an intensity H of the magnetic field detected by the magnetic sensor 38.

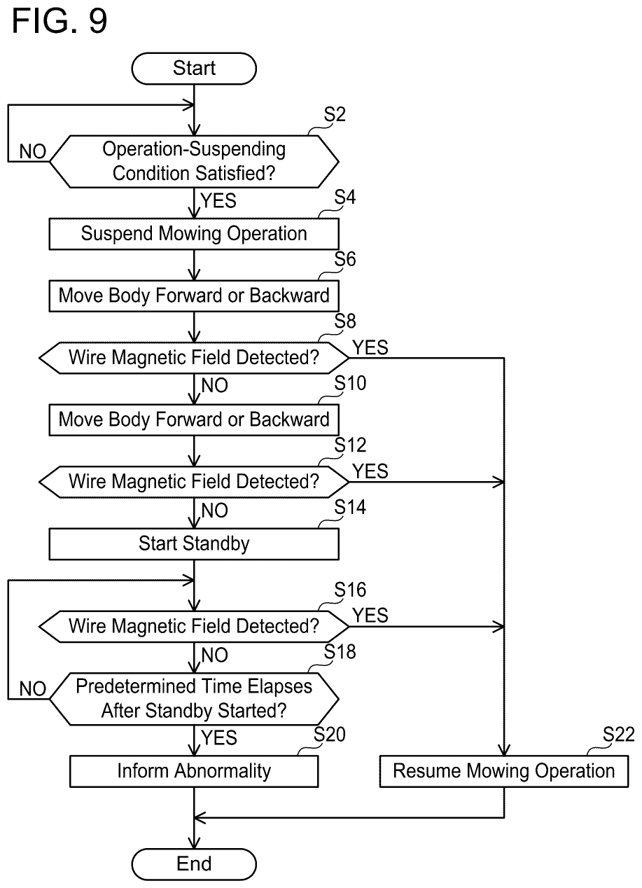

The wire magnetic field M however stops being generated when the application of the electrical signal on the wire 112 is stopped when the wire 112 is broken/disconnected or a power outage occurs. When the wire magnetic field M stops being generated, the wire magnetic field M becomes undetected by the magnetic sensor 38 no matter which of the inside, the boundary, and the outside of the working area WA the magnetic sensor 38 is at. As a result of this, the control unit 8 becomes unable to determine the positional relationship between the body 4 and the wire 112. The control unit 8 repeatedly executes processes illustrated in FIG. 9 during execution of the mowing operation in preparation for such situations.

In S2, the control unit 8 assesses whether the predetermined operation-suspending condition is satisfied or not. The operation-suspending condition is a condition based on which it is assumed that the wire magnetic field M is not generated, and in the present embodiment it is that the wire magnetic field becomes undetected by three or more of the four magnetic sensors 38a, 38b, 38c, 38d. In a case where the operation-suspending condition is not satisfied (in case of NO), S2 is repeatedly executed. When the operation-suspending condition is satisfied, the process proceeds to S4.

In S4, the control unit 8 suspends the mowing operation in execution. Specifically, the control unit 8 stops the movement motors 32L, 32R and the working motor 36. After S4, the process proceeds to S6.

In S6, the control unit 8 causes the movement motors 32L, 32R to operate and causes the body 4 to go forward or backward by a first distance. In doing so, the control unit 8 determines a moving direction in which the body 4 was moving before the mowing operation was suspended in S4, and causes the body 4 to move in an opposite direction from the determined moving direction. For example, in a case where the body 4 was moving forward before the mowing operation was suspended in S4, the control unit 8 causes the body 4 to go backward in S6, whereas in a case where the body 4 was moving backward before the mowing operation was suspended in S4, the control unit 8 causes the body 4 to move forward in S6. The first distance is set to 1000 mm or less, and less than or equal to a total length of the robotic mower 2. In the present embodiment, the first distance is set to 100 mm. After S6, the process proceeds to S8.

In S8, the control unit 8 assesses whether the wire magnetic field M was detected by the magnetic sensors 38a, 38b, 38c, 38d while the control unit 8 was causing the body 4 to move in S6. Specifically, the control unit 8 assesses whether the number of the magnetic sensors 38 among the four magnetic sensors 38a, 38b, 38c, 38d which detects the wire magnetic field M has become two or more. In a case where the number of the magnetic sensors 38 (among the four magnetic sensors 38a, 38b, 38c, 38d) which detects the wire magnetic field M is not two or more (in case of NO), the process proceeds to S10.

In S10, the control unit 8 causes the movement motors 32L, 32R to operate and causes the body 4 to move forward or backward by a second distance. In doing so, the control unit 8 causes the body 4 to move in an opposite direction from the moving direction of the body 4 in S6. For example, in a case where the control unit 8 caused the body 4 to move forward in S6, the control unit 8 causes the body 4 to go backward in S8. Whereas on the other hand, in a case where the control unit 8 caused the body 4 to go backward in S6, the control unit 8 causes the body 4 to go forward in S8. The second distance is set to 1000 mm or less, less than or equal to the total length of the robotic mower 2, and shorter than the first distance. In the present embodiment, the second distance is set to 50 mm. After S10, the process proceeds to S12.

In S12, the control unit 8 assesses whether the wire magnetic field M was detected by the magnetic sensors 38a, 38b, 38c, 38d while the control unit 8 was causing the body 4 to move in S10. Specifically, the control unit 8 assesses whether the number of the magnetic sensors 38 among the four magnetic sensors 38a, 38b, 38c, 38d which detects the wire magnetic field M has become two or more. In a case where the number of the magnetic sensors 38 which detects the wire magnetic field M is not two or more (in case of NO), the process proceeds to S14.

In S14, the control unit 8 causes the body 4 to be in standby with the movement motors 32L, 32R and the working motor 36 stopped. After S14, the process proceeds to S16.

In S16, the control unit 8 assesses whether the wire magnetic field M was detected by the magnetic sensors 38a, 38b, 38c, 38d. Specifically, the control unit 8 assesses whether the number of the magnetic sensors 38 among the four magnetic sensors 38a, 38b, 38c, 38d which detects the wire magnetic field M has become two or more. In a case where the number of the magnetic sensors 38 which detects the wire magnetic field M is not two or more (in case of NO), the process proceeds to S18.

In S18, the control unit 8 assesses whether a time elapsed since when the standby started in S14 becomes a predetermined duration (e.g., 15 minutes) or more. In a case where the time elapsed since when the standby started in S14 is shorter than the predetermined duration (in case of NO), the process returns to S16. In a case where the time elapsed since when the standby started in S14 becomes the predetermined duration or more (in case of YES), the process proceeds to S20.

In S20, the control unit 8 informs that abnormality has occurred by sound and/or light by operating the display unit 11 and/or the alarm unit 52 disposed in the body 4. Alternatively, the control unit 8 may communicate with a communication terminal (e.g., smartphone) the user has via the communication unit 50, and thus may cause the communication terminal to inform of occurrence of abnormality. For example, the control unit 8 may cause the communication terminal the user has to display a message indicating that an abnormality has occurred. The abnormality herein mentioned is specifically that the wire magnetic field M is not detected by the magnetic sensors 38. After S20, the processes illustrated in FIG. 9 is finished.

In the case where the number of the magnetic sensors 38, among the four magnetic sensors 38a, 38b, 38c, 38d, which detects the wire magnetic field M has become two or more in S8, S12, or S16 (that is, in case of YES in S8, S12, or S16), the process proceeds to S22. In S22, the control unit 8 restarts the mowing operation which was suspended in S4. Specifically, the control unit 8 causes the movement motors 32L, 32R and the working motor 36 to operate and thus restarts the mowing work by the robotic mower 2. After S22, the processes illustrated in FIG. 9 end.

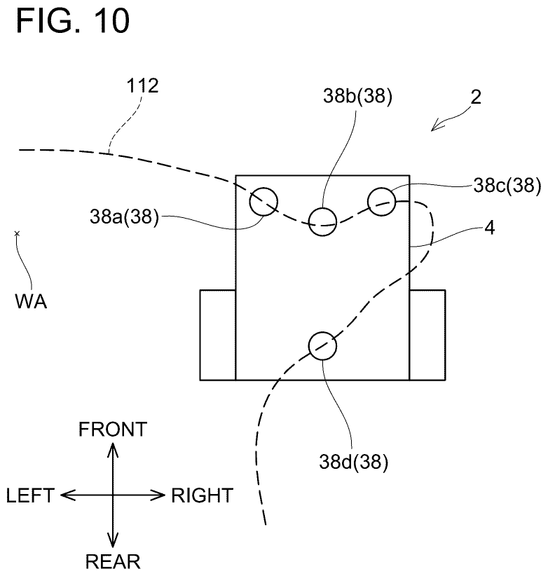

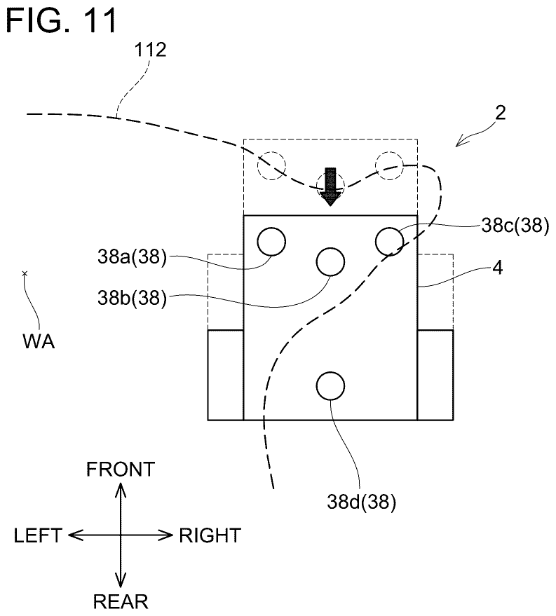

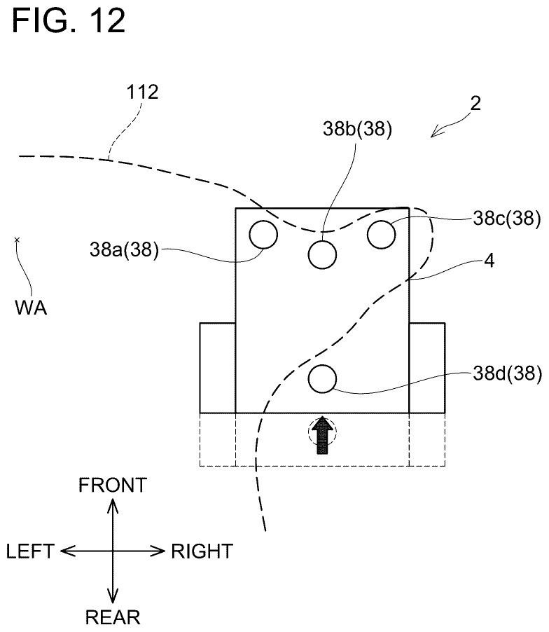

In a case where each of the plurality of magnetic sensors 38 is located directly above the wire 112 (i.e., boundary of the working area WA) as illustrated in FIG. 10 for example, the wire magnetic field M becomes undetected by each of the plurality of magnetic sensors 38 even when the wire magnetic field M (see FIG. 8) is generated. Since the operation-suspending condition is satisfied in this situation, the mowing operation is suspended. If the body 4 is caused to stay in standby without being moved after the mowing operation has been suspended, the wire magnetic field M may not be detected at all by each of the plurality of magnetic sensors 38 because the situation where each of the plurality of magnetic sensors 38 is located directly above the wire 112 cannot be resolved. In this case, because the mowing operation is not resumed at all, the mowing work by the robotic mower 2 may not proceed smoothly. Contrary to this, according to the processes illustrated in FIG. 9, detection for the wire magnetic field M by the plurality of magnetic sensors 38 can be attempted while causing the body 4 to move backward after the mowing operation has been suspended, as illustrated in FIG. 11, for example. Thereafter, as illustrated in FIG. 12, detection for the wire magnetic field M by the plurality of magnetic sensors 38 can be attempted while causing the body 4 to move forward. Due to these features, because the situation where each of the plurality of magnetic sensors 38 is located directly above the wire 112 is resolved, the wire magnetic field M becomes detected by each of the plurality of magnetic sensors 38 should it be generated, and accordingly the mowing operation is resumed. Consequently, according to the processes illustrated in FIG. 9, the mowing work by the robotic mower 2 can be smoothly proceeded.

If, however the wire magnetic field M stops being generated due to breakage/disconnection of the wire 112, the wire magnetic field M cannot be detected by the plurality of magnetic sensors 38 even if detection for the wire magnetic field M by the plurality of magnetic sensors 38 is attempted by causing the body 4 to move. Due to this, if the wire magnetic field M stops being generated, the situation in which the wire magnetic field M cannot be detected by the magnetic sensors 38 would continue. According to the processes illustrated in FIG. 9, in the case where the situation where the wire magnetic field M cannot be detected by the magnetic sensors 38 continues, it is informed that abnormality has occurred. Accordingly, when the wire magnetic field M stops being generated, it is possible to let the user acknowledge that situation.

### (Modifications)

The working robot may be a robot other than the robotic mower 2. For example, the working robot may be a robotic cleaner comprising a brush for collecting trash such as dust and/or a vacuum mechanism. In this case, the working motor 36 may be implemented as a motor configured to drive the brush and/or vacuum mechanism. Also, the working robot may be a rebar tying robot comprising a rebar tying mechanism configured to tie a plurality of rebars at a point where the plurality of rebars intersects. In this case, the working motor 36 may be implemented as a motor configured to drive the rebar tying mechanism.

The robotic mower 2 may have a power cord connected to an external power supply (e.g., commercial power source) attached thereto. In this case, the robotic mower 2 may be configured to operate with power supplied from the external power supply through the power cord.

The robotic mower 2 may not comprise the battery 18. Alternatively, a rechargeable battery pack such as a lithium-ion battery may be detachably attached to the body 4. In this case, the robotic mower 2 may be configured to operate with power supplied from the battery pack.

The robotic mower 2 may not perform work while moving in the working area WA encircled by the wire 112. For example, the robotic mower 2 may perform work while moving along the wire 112. In this case, the control unit 8 may calculate a distance between the magnetic sensor(s) 38 and the wire 112 based on the intensity of the wire magnetic field M detected by the magnetic sensor(s) 38 and thus cause the body 4 to move such that the magnetic sensor(s) 38 do not separate from the wire 112.

In S6 in the processes illustrated in FIG. 9, the control unit 8 may cause the body 4 to turn (or rotate) leftward or rightward by rotating the driving wheels 30L, 30R at different speeds, instead of causing the body 4 to move forward or backward. Alternatively, in S6 of the processes illustrated in FIG. 9, the control unit 8 may firstly cause the body 4 to move forward or backward by rotating the driving wheels 30L, 30R at the same speed, and then cause the body 4 to turn (rotate) leftward or rightward by rotating the driving wheels 30L, 30R at different speeds. Also, in S10 of the processes illustrated in FIG. 9, the control unit 8 may cause the body 4 to turn (or rotate) leftward or rightward by rotating the driving wheels 30L, 30R at different speeds, instead of causing the body 4 to move forward or backward. Alternatively, in S10 of the processes illustrated in FIG. 9, the control unit 8 may firstly cause the body 4 to move forward or backward by rotating the driving wheels 30L, 30R at the same speed, and then cause the body 4 to turn (rotate) leftward or rightward by rotating the driving wheels 30L, 30R at different speeds.

The movement unit 12 may further comprise a steering mechanism configured to rotate each of the driving wheels 30L, 30R to rotate about an axis extending along the up-down direction. Such steering mechanism may allow rotation axes of the driving wheels 30L, 30R to be disposed along a direction different from the left-right direction (e.g., front-rear direction). In this case, in S6, S10 of the processes illustrated in FIG. 9, the control unit 8 may firstly dispose the rotation axes of the driving wheels 30L, 30R along the front-rear direction by using the steering mechanism, and then may cause the driving wheels 30L, 30R to rotate at the same speed. Due to this, the body 4 may be caused to move straight to the left or to the right.

The movement unit 12 may comprise another moving mechanism (e.g., crawler, side-stepper) instead of the casters 28L, 28R and the driving wheels 30L, 30R. The side stepper herein mentioned is a mechanism configured to move the body 4 in the left-right direction. In a case where the movement unit 12 comprises the side stepper, in S6, S10 of the processes illustrated in FIG. 9, the control unit 8 may drive the side stepper and thus cause the body 4 to move straight to the left or to the right.

The operation-suspending condition may vary from that of the present embodiment. For example, the operation-suspending condition may be that the wire magnetic field M becomes undetected by all the magnetic sensors 38a, 38b, 38c, 38d. In this case, in S8, S12, S16 of the processes illustrated in FIG. 9, the control unit 8 may assess YES in a case where the wire magnetic field M is detected by one or more magnetic sensors 38. Further, the operation-suspending condition may be that the wire magnetic field M becomes undetected by two or more of the four magnetic sensors 38a, 38b, 38c, 38d. In this case, in S8, S12, S16 of the processes illustrated in FIG. 9, the control unit 8 may assess YES in a case where the wire magnetic field M is detected by three or more of the magnetic sensors 38.

In the processes illustrated in FIG. 9, after S6, the control unit 8 may skip S8 and execute S10. That is, the control unit 8 may be configured to cause the body 4 to move again irrespective of whether the wire magnetic field M was detected or not by the magnetic sensor(s) 38 while the body 4 was being caused to move in S6.

In a case where NO is assessed in S8 in the processes illustrated in FIG. 9, the control unit 8 may skip S10 and S12, and execute S14. That is, the control unit 8 may be configured not to cause the body 4 to move until the wire magnetic field M is detected by the magnetic sensor(s) 38 after suspending the mowing operation and then causing the body 4 to move by the first distance.

In the processes illustrated in FIG. 9, in the case where NO is assessed in S12, the control unit 8 may skip S14, S16, S18 and execute S20. That is, in a case where the wire magnetic field M is not detected by the magnetic sensor(s) 38 even after causing the body 4 to move, the control unit 8 may immediately inform of the occurrence of abnormality without being in standby.

In S20 of the processes illustrated in FIG. 9, the control unit 8 may not inform of the occurrence of abnormality. Alternatively, the control unit 8 may turn off the main power of the robotic mower 2.

The total number of the magnetic sensors 38 which the robotic mower 2 comprises may be four or more or less than four. In this case also, the operation-suspending condition may be that the wire magnetic field M becomes undetected by more than a half of the magnetic sensors 38. Further, in S8, S12, S16 of the processes illustrated in FIG. 9, the control unit 8 may assess YES in a case where the wire magnetic field M is detected by more than a half of the magnetic sensors 38.

The moving distance (first distance) of the body 4 in S6 of the processes illustrated in FIG. 9 may be different from that of the embodiment. For example, the first distance may be more than 1000 mm and/or may be more than the total length of the robotic mower 2. The moving distance (second distance) of the body 4 in S10 of the processes illustrated in FIG. 9 may be different from that of the embodiment. For example, the second distance may be more than 1000 mm, may be more than the total length of the robotic mower 2, and/or equal to or more than the first distance. For example, the second distance may equal to the first distance.

The moving direction of the body 4 in S6 of the processes illustrated in FIG. 9 may not be the opposite direction from the moving direction before the mowing operation is suspended in S4. For example, in S6 the control unit 8 may randomly determine in which direction to move the body 4, forward or backward. Further, the moving direction of the body 4 in S10 may not be the opposite direction from the moving direction before the mowing operation is suspended in S6. For example, in S10 the control unit 8 may randomly determine in which direction to move the body 4, forward or backward.

### Features in Embodiment

Given the above, in one or more embodiments, the robotic mower 2 is used in the site 100 (example for a working field) in which the wire 112 is installed, and is configured to move and work based on the wire magnetic field M generated around the wire 112. The robotic mower 2 comprises: the body 4; the movement unit 12 configured to move the body 4; the working unit 14 supported by the body 4; the magnetic sensors 38 supported by the body 4; and the control unit 8. The control unit 8 is configured to execute the mowing operation (example for a working operation) of causing the working unit 14 to work while causing the movement unit 12 to move the body 4. The control unit 8 executes, during the mowing operation: the operation-suspending process (see S2, S4 in the processes illustrated in FIG. 9) of suspending the mowing operation when a predetermined operation-suspending condition is satisfied; a first magnetic field searching process (see S6, S8 in the processes illustrated in FIG. 9) of causing the movement unit 12 to move the body 4 straight to the front or to the back (example for a first linear direction) by the first distance and assessing whether the wire magnetic field M is detected by the magnetic sensors 38 after the operation-suspending process; and an operation-resuming process (see S22 in the processes illustrated in FIG. 9) of resuming the mowing operation when the wire magnetic field M is detected by the magnetic sensors 38.

Even in a case where it is expected that the wire magnetic field M will not be detected by the magnetic sensors 38, the wire magnetic field M may be detected by the magnetic sensor(s) 38 when a positional relationship between the magnetic sensor(s) 38 and the wire 112 is changed. According to the above configuration, when the operation-suspending condition is satisfied (when it is expected that the wire magnetic field M will not be detected by the magnetic sensor(s) 38), detection for the wire magnetic field M by the magnetic sensor(s) 38 can be attempted while changing the positional relationship between the magnetic sensor(s) 38 and the wire 112. Due to this, the situation where the wire magnetic field M is undetected by the magnetic sensor(s) 38 despite the wire magnetic field M being generated can be suppressed from continuing. Further, when the wire magnetic field M is detected by the magnetic sensor(s) 38 during the suspension of the mowing operation, the control unit 8 can automatically resume the mowing operation. Due to this, the mowing operation can be resumed without a user's help, and the work using the robotic mower 2 can be smoothly proceeded.

In one or more embodiments, the operation-suspending condition includes that the wire magnetic field M becomes undetected by the magnetic sensors 38.

According to the above configuration, when the wire magnetic field M becomes undetected by the magnetic sensor(s) 38 even while the wire magnetic field M is generated, the operation-suspending condition is satisfied, by which the mowing operation is suspended. However, when the operation-suspending condition is satisfied, the control unit 8 can attempt to detect the wire magnetic field M while changing the positional relationship between the magnetic sensor(s) 38 and the wire 112. Due to this, the situation in which the wire magnetic field M is undetected by the magnetic sensor(s) 38 despite the wire magnetic field M being generated can be suppressed from continuing.

In one or more embodiments, the robotic mower 2 comprises the four magnetic sensors 38a, 38b, 38c, 38d (example for a plurality of magnetic sensors). The operation-suspending condition includes that the wire magnetic field M becomes undetected by a predetermined number (three) or more magnetic sensors 38 among the four magnetic sensors 38a, 38b, 38c, 38d, and the predetermined number (three) is greater than a half (two) of a total (four) of the plurality of magnetic sensors 38.

As to the wire magnetic field M generated around the wire 112, intensity of the magnetic field in the up-down direction is substantially zero directly above the wire 112 or directly below the wire 112. Due to this, in a case where the magnetic sensors 38 are configured to observe a vertical magnetic field (magnetic field in the up-down direction), the wire magnetic field M becomes undetected by the magnetic sensor 38 when that magnetic sensor 38 is positioned directly above the wire 112. There is a technique which uses this characteristic to determine that a magnetic sensor 38 is positioned directly above the wire 112 when the wire magnetic field M is not detected by that magnetic sensor 38. Considering this technique, even if the wire magnetic field M was undetected by some of the plurality of magnetic sensors 38, it is highly probable that the wire magnetic field M is generated when the number of the magnetic sensors 38 which do not detect the wire magnetic field M is small. If the series of processes following the operation-suspending process is performed in this case also, the mowing operation results in being unnecessarily suspended, and thus the work using the robotic mower 2 cannot proceed smoothly. According to the above configuration, when the number of the magnetic sensors 38 which does not detect the wire magnetic field M is large, the operation-suspending condition is satisfied, by which the series of processes following the operation-suspending process is performed. When the number of the magnetic sensors 38 which does not detect the wire magnetic field M is small, the operation-suspending condition is not satisfied, by which the series of processes following the operation-suspending process is not performed. As such, the series of processes following the operation-suspending process is performed only when it is less probable that the wire magnetic field M is generated, the unnecessary suspension of the mowing operation can be suppressed. Due to this, the work using the robotic mower 2 can be smoothly proceeded.

In one or more embodiments, the wire magnetic field M includes a wire magnetic signal generated by applying a predetermined electrical signal to the wire 112. The control unit 8 has the signal model SM of the wire magnetic signal stored therein in advance. When a magnetic signal observed by the magnetic sensor 38 matches or resembles the signal model SM of the wire magnetic signal, the control unit 8 assesses that the wire magnetic field M is detected by that magnetic sensor 38.

According to the above configuration, whether the wire magnetic field M is detected or not by the magnetic sensor(s) 38 can be determined with a simple means.

In one or more embodiments, the control unit 8 is configured to determine a direction in which the body 4 moved before the mowing operation is suspended and set an opposite direction from the determined direction as the first linear direction in the first magnetic field searching process.

There is a case where, in the example where an area surrounded by the wire 112 is defined as the working area WA for the robotic mower 2, the operation-suspending condition may be satisfied when the magnetic sensor(s) 38 come directly above the wire 112 and thus the wire magnetic field M becomes undetected by the magnetic sensor(s) 38. In this case, because the body 4 is assumed as being on or near the boundary of the working area WA, the body 4 may go outside the working area WA if the body 4 is randomly moved in the first magnetic field searching process executed thereafter. According to the above configuration, the control unit 8 causes the body 4 to return to a spot at which the body 4 was before the operation-suspending condition was satisfied in the first magnetic field searching process. Since the wire magnetic field M must have been detected by the magnetic sensor(s) 38 right before the operation-suspending condition was satisfied, it can be assumed that the body 4 was inside the working area WA. Accordingly, the body 4 can be moved so as to approach the inside of the working area WA, and thus the body 4 can be suppressed from going outside the working area WA.

In one or more embodiments, after the first magnetic field searching process, the control unit 8 is configured to further execute a second magnetic field searching process (see S10, S12 in the processes illustrated in FIG. 9) of causing the movement unit 12 to move the body 4 straight to the back or to the front (example for a second linear direction opposite to the first linear direction) by the second distance and assessing whether the wire magnetic field M is detected by the magnetic sensor 38.

According to the above configuration, after the first magnetic field searching process, detection for the wire magnetic field M by the magnetic sensor(s) 38 can be attempted while changing the positional relationship between the magnetic sensor(s) 38 and the wire 112 again. Due to this, the situation where the wire magnetic field M is undetected by the magnetic sensor(s) 38 despite the wire magnetic field M being generated can be more certainly resolved.

In one or more embodiments, when the wire magnetic field M is detected in the first magnetic field searching process, the control unit 8 does not execute the second magnetic field searching process, and when the wire magnetic field M is not detected in the first magnetic field searching process, the control unit 8 executes the second magnetic field searching process.

According to the above configuration, in the case where the wire magnetic field M is detected in the first magnetic field searching process, the control unit 8 can omit the second magnetic field searching process and immediately resume the mowing operation. Due to this, the work using the robotic mower 2 can be smoothly proceeded.

In one or more embodiments, the second distance is the same as the first distance.

If the mowing operation is resumed at a spot different from the spot at which the mowing operation was suspended, the mowing operation may possibly end with a spot at which the robotic mower 2 has not worked on yet (undone spot) remaining. According to the above configuration, the position of the body 4 when the second magnetic field searching process is finished is almost not displaced from the position of the body 4 when the mowing operation was suspended. Due to this, the mowing operation can be resumed from the spot at which the mowing operation was suspended by resuming the mowing operation after the second magnetic field searching process is finished. Accordingly, the mowing operation can be suppressed from ending with an undone spot remaining.

In one or more embodiments, the second distance is less than the first distance.

There is a case where the operation-suspending condition may be satisfied when the magnetic sensor(s) 38 come directly above the wire 112 and accordingly the wire magnetic field M becomes undetected by the magnetic sensor(s) 38. In this case, if the position of the body 4 when the second magnetic field searching process is finished is not displaced at all from the position of the body 4 when the wire magnetic field M becomes undetected by the magnetic sensor(s) 38, the magnetic sensor(s) 38 would go again directly above the wire 112. Due to this, even if the wire magnetic field M is detected in the first magnetic field searching process or in the second magnetic field searching process, the wire magnetic field M may become undetected by the magnetic sensor(s) 38 after the second magnetic field searching process has finished. As a result, even if the mowing operation is resumed, the mowing operation would be immediately suspended, as a result of which the work using the robotic mower 2 may not smoothly proceeded. According to the above configuration, the position of the body 4 when the second magnetic field searching process is finished can be displaced from the position of the body 4 when the wire magnetic field M becomes undetected by the magnetic sensor(s) 38. Due to this, the magnetic sensor(s) 38 can be suppressed from coming directly above the wire 112 when the second magnetic field searching process is finished. Due to this, as long as the wire magnetic field M is generated, even after the second magnetic field searching process is finished, the wire magnetic field M can be detected by the magnetic sensor(s) 38. Accordingly, because the mowing operation can be suppressed from being suspended immediately after the mowing operation is resumed, the work using the robotic mower 2 can be smoothly proceeded.

In one or more embodiments, the first distance is less than or equal to 1000 mm.

If the body 4 is moved to a great degree after the wire magnetic field M has become undetected by the magnetic sensor(s) 38, the body 4 may be gone to an unexpected spot (e.g., a spot where an obstacle is present). According to the above configuration, the body 4 can be suppressed from moving to a great degree after the wire magnetic field M has become undetected by the magnetic sensor(s) 38. Accordingly, the body 4 can be suppressed from going to an unexpected spot.

In one or more embodiments, the first distance is less than or equal to the total length of the robotic mower 2.

If the body 4 is moved to a great degree after the wire magnetic field M has become undetected by the magnetic sensor(s) 38, the body 4 may be gone to an unexpected spot (e.g., a spot where an obstacle is present). According to the above configuration, the body 4 can be suppressed from moving to a great degree after the wire magnetic field M has become undetected by the magnetic sensor(s) 38. Accordingly, the body 4 can be suppressed from going to an unexpected spot.

In one or more embodiments, the control unit 8 is configured to further execute an informing process (see S20 in the processes illustrated in FIG. 9) of informing via the display unit 11, the alarm unit 52 and/or the communication unit 50 (examples for an informing interface) that the wire magnetic field M is not detected by the magnetic sensors 38 (example for an abnormality having occurred). When fifteen minutes (example for a predetermined time) elapses without the operation-resuming process being executed after the first magnetic field searching process has finished, the control unit 8 executes the informing process.

According to the above configuration, in a case where the wire magnetic field M is not detected by the magnetic sensor(s) 38 and thus the mowing operation is not resumed even after the first magnetic field searching process, it is possible to inform the user of that situation.

In one or more embodiments, the control unit 8 is configured to further execute an informing process (see S20 in the processes illustrated in FIG. 9) of informing via the display unit 11, the alarm unit 52 and/or the communication unit 50 (examples for an informing interface) that the wire magnetic field M is not detected (example for an abnormality having occurred). When fifteen minutes (example for a predetermined time) elapses without the operation-resuming process being executed after the second magnetic field searching process has finished, the control unit 8 executes the informing process.

According to the above configuration, in a case where the wire magnetic field M is not detected by the magnetic sensor(s) 38 and thus the mowing operation is not resumed even after the first magnetic field searching process and the second magnetic field searching process, it is possible to inform the user of that situation.

In one or more embodiments, the working unit 14 comprises the blade 34 configured to mow the lawn. The working robot functions as an autonomous mobile robotic mower 2.

According to the above configuration, the mowing operation by the robotic mower 2 can be smoothly proceeded.

What is claimed is:

1. A working robot used in a working field in which a wire is installed, and configured to move and work based on a wire magnetic field generated around the wire, the working robot comprising:
a body;
a movement unit configured to move the body;
a working unit supported by the body;
a magnetic sensor supported by the body; and
a control unit,
wherein the control unit is configured to execute a working operation of causing the working unit to work while causing the movement unit to move the body,
the control unit executes, during the working operation:
an operation-suspending process of suspending the working operation when a predetermined operation-suspending condition is satisfied;
a first magnetic field searching process of causing the movement unit to move the body straight in a first linear direction by a first distance and assessing whether the wire magnetic field is detected by the magnetic sensor after the operation-suspending process; and
an operation-resuming process of resuming the working operation when the wire magnetic field is detected by the magnetic sensor.

2. The working robot according to claim 1, wherein the operation-suspending condition includes that the wire magnetic field becomes undetected by the magnetic sensor.

3. The working robot according to claim 1, wherein the magnetic sensor comprises a plurality of magnetic sensors,
the operation-suspending condition includes that the wire magnetic field becomes undetected by a predetermined number or more of magnetic sensors among the plurality of magnetic sensors, and
the predetermined number is greater than a half of a total of the plurality of magnetic sensors.

4. The working robot according to claim 1, wherein the wire magnetic field includes a wire magnetic signal generated by applying a predetermined electrical signal to the wire,
the control unit has a signal model of the wire magnetic signal stored therein in advance, and
when a magnetic signal observed by the magnetic sensor matches or resembles the signal model of the wire magnetic signal, the control unit assesses that the wire magnetic field is detected by the magnetic sensor.

5. The working robot according to claim 1, wherein the control unit is configured to determine a direction in which the body moved before the working operation is suspended and set an opposite direction from the determined direction as the first linear direction in the first magnetic field searching process.

6. The working robot according to claim 1, wherein after the first magnetic field searching process, the control unit is configured to further execute a second magnetic field searching process of causing the movement unit to move the body straight in a second linear direction opposite to the first linear direction by a second distance and assessing whether the wire magnetic field is detected by the magnetic sensor.

7. The working robot according to claim 6, wherein when the wire magnetic field is detected in the first magnetic field searching process, the control unit does not execute the second magnetic field searching process, and
when the wire magnetic field is not detected in the first magnetic field searching process, the control unit executes the second magnetic field searching process.

8. The working robot according to claim 6, wherein the second distance is the same as the first distance.

9. The working robot according to claim 6, wherein the second distance is less than the first distance.

10. The working robot according to claim 1, wherein the first distance is less than or equal to 1000 mm.

11. The working robot according to claim 1, wherein the first distance is less than or equal to a total length of the working robot.

12. The working robot according to claim 1, wherein the control unit is configured to further execute an informing process of informing via an informing interface that an abnormality has occurred, and
when a predetermined time elapses without the operation-resuming process being executed after the first magnetic field searching process has finished, the control unit executes the informing process.

13. The working robot according to claim 6, wherein the control unit is configured to further execute an informing process of informing via an informing interface that an abnormality has occurred, and
when a predetermined time elapses without the operation-resuming process being executed after the second magnetic field searching process has finished, the control unit executes the informing process.

14. The working robot according to claim 1, wherein the working unit comprises a blade configured to mow a lawn, and
the working robot functions as an autonomous mobile robotic mower.

15. The working robot according to claim 1, wherein
the magnetic sensor comprises a plurality of magnetic sensors,
the operation-suspending condition includes that the wire magnetic field becomes undetected by a predetermined number or more of magnetic sensors among the plurality of magnetic sensors,
the predetermined number is greater than a half of a total of the plurality of magnetic sensors,
the wire magnetic field includes a wire magnetic signal generated by applying a predetermined electrical signal to the wire,
the control unit has a signal model of the wire magnetic signal stored therein in advance,
when a magnetic signal observed by the magnetic sensor matches or resembles the signal model of the wire magnetic signal, the control unit assesses that the wire magnetic field is detected by the magnetic sensor,
the control unit configured to determine a direction in which the body moved before the working operation is suspended and set an opposite direction from the determined direction as the first linear direction in the first magnetic field searching process,
after the first magnetic field searching process, the control unit is configured to further execute a second magnetic field searching process of causing the movement unit to move the body straight in a second linear direction opposite to the first linear direction by a second distance and assessing whether the wire magnetic field is detected by the magnetic sensor,
when the wire magnetic field is detected in the first magnetic field searching process, the control unit does not execute the second magnetic field searching process,
when the wire magnetic field is not detected in the first magnetic field searching process, the control unit executes the second magnetic field searching process,
the second distance is less than the first distance,
the first distance is less than or equal to 1000 mm,
the first distance is less than or equal to a total length of the working robot,
the control unit is configured to further execute an informing process of informing via an informing interface that an abnormality has occurred,
when a predetermined time elapses without the operation-resuming process being executed after the second magnetic field searching process has finished, the control unit executes the informing process,
the working unit comprises a blade configured to mow a lawn, and
the working robot functions as an autonomous mobile robotic mower.
